(19) United States
(12) Patent Application Publication
(10) Pub. No.: US 2008/0300071 A1
(43) Pub. Date: Dec. 4, 2008

(54) REAL TIME SCORING, FEEDBACK, AND LONGTERM STATISTICS TRACKING SYSTEM

(76) Inventor: Tom C. Valaika, Chattanooga, TN (US)

Correspondence Address: Michael R. Henson & Associates, LLC, 5613 DTC Parkway, Suite 240, Greenwood Village, CO, 80111, US

(21) Appl. No.: 12/129,591

(22) Filed: May 29, 2008

Related U.S. Application Data
(60) Provisional application No. 60/940,634, filed on May 29, 2007.

(51) Int. Cl. A63B 69/00

(52) U.S. Cl. 473/422

(57) ABSTRACT

An improvement for a practice facility that simulates a sport playing environment, wherein the facility has a projectile striking region and a target region for the projectile. The improvement is a computerized feedback system that includes an input device for receiving participant credentials sufficient to activate the computerized feedback system and an output device for displaying perceptible output to a participant. A target array including at least one target is removably mounted in the target region and operative, when stimulated by the projectile, to produce at least one feedback signal. A data processing device is included that is adapted to receive each feedback signal produced by the target array, process selected feedback signals according to rules for the sport in order to generate processed data, and selectively transmit the processed data to the output device.

### BACKGROUND

Recreational sports in the United States are extremely popular among people of almost all age groups. Peewee soccer, peewee baseball, and adult softball, baseball, and soccer leagues are just a few examples of organized recreational activities enjoyed by sports enthusiasts.

The popularity of these sports has driven growth in an industry that provides practice equipment and practice facilities to sports enthusiasts. A batting cage is an example of such a facility that allows players to practice hitting baseballs or softballs, which are mechanically thrown to the batter. These mechanical pitching machines usually include a rotating wheel or arm that throws the ball, a ball hopper, and a means to automatically collect the balls. A similar concept is employed to launch tennis balls and soccer balls to practicing players. The players receive feedback based on how far and what direction the ball travels once hit or kicked. This feedback is subjective and typically is not recorded for comparison to subsequent or previous performance.

Over the past 30 years or so, changes have been made to improve practice equipment. The main improvements have been more accurate pitching and rolling machines and the introduction of selectable pitching/rolling speeds. Although some changes have been made to the pitching/rolling equipment, an opportunity for improving the overall experience of simulated play still exists. This opportunity arises from the fact that some players who enjoy recreational sports cannot endure the physical stress or time commitments normally associated with participating in an organized league. Also, parents and children usually belong to separate leagues based on age. Thus, there is no known way for both age groups to compete against one another fairly while enjoying the scoring aspects of their chosen sport.

Accordingly, there is a need for equipment and facilities that can simulate a league experience with head-to-head competition without the commitment of time or the rigors of actual play. In addition, there is a need for a practice facility that can pit players of different skill levels or abilities against one another while accounting for their differences in ability to make for a competitive experience.

### SUMMARY

Provided herein is an improvement for a practice facility that simulates a sport playing environment, wherein the facility has a projectile striking region and a target region for the projectile. The improvement is a computerized feedback system that includes an input device for receiving participant credentials sufficient to activate the computerized feedback system and an output device for displaying perceptible output to a participant. A target array including at least one target is removably mounted in the target region and operative, when stimulated by the projectile, to produce at least one feedback signal. A data processing device is included that is adapted to receive each feedback signal produced by the target array, process selected feedback signals according to rules for the sport in order to generate processed data, and selectively transmit the processed data to the output device.

The target array may include a plurality of targets correlated to the sport and be stimulated upon impact by the projectile. The input device, such as a card reader, and the output device may be included in a kiosk. The participant's credentials and selected processed data may be stored on a memory device readable by the kiosk. The data processing device may also be adapted to update the data stored on the memory device.

Also contemplated is a gaming system for simulating a competitive sport involving a projectile that includes a plurality of practice facilities each including a simulated playing environment correlated to the sport, wherein the playing environment has a projectile striking region and a target region for the projectile. Each practice facilities also includes a target array including at least one target removably mounted in the target region and operative, when stimulated by the projectile, to produce at least one feedback signal. A kiosk is included in each practice facility that includes an input device for receiving participant credentials and an output device for displaying perceptible output to the participant. The gaming system includes a data processing system including at least one data processing device associated with each facility. The data processing system is adapted to receive feedback signals produced by the target arrays, process selected ones of the feedback signals according to rules for the sport in order to generate processed data, and selectively transmit the processed data to the output devices. Each of the kiosks may include a data processing device.

The data processing system may be adapted to determine relative skill levels among participants in order to generate ranking data. Selected ranking data may be stored on a memory device readable by the kiosk. The data processing system is adapted to update data, such as ranking data, stored on the memory device. The sport may be selected from the group consisting of baseball, softball, soccer, tennis, hockey, and golf, for example.

### BRIEF DESCRIPTION OF THE DRAWINGS

FIG. 1 is a perspective view of a batting cage according to the exemplary embodiment of the present invention showing the interconnection of the scoring targets, computer kiosk, server, database, and Internet;

FIG. 2 is a front view in elevation of the batting cage shown in FIG. 1 further illustrating the scoring targets;

FIG. 3 is a partial cross-section of a target showing the construction of the target and sensor mounting;

FIG. 4 is a perspective view of the kiosk introduced in FIG. 1 as viewed from the front of the kiosk;

FIG. 5 is a schematic representation of a network interconnecting a plurality of practice facilities with a database;

FIG. 6 is a perspective view of a soccer practice cage showing the interconnection of the scoring targets, computer kiosk, server, database, and Internet;

FIG. 7 is a front view in elevation of the soccer practice cage shown in FIG. 4 further illustrating the scoring targets; and

FIG. 8 is a perspective view of the kiosk shown in FIG. 4 as viewed from the front of the kiosk.

### DETAILED DESCRIPTION

Provided herein is a real-time scoring feedback and long term statistical tracking system. The system includes scoring targets with sensors, computer hardware, software database technology, and display or point-of-sale kiosks. The targets can be adjusted and configured to simulate a multitude of different sports. In addition, the system can be configured for retrofit installation on existing practice facilities such as a batting cage facility. The exemplary embodiment of the present invention is described with respect to the games of baseball, softball, and soccer. It should be understood, however, that the invention may be applied to other games, such as tennis, hockey, and golf, where a projectile is directed by the actions of a player. The scoring system also allows players of all ages to compete against one another, regardless of skill or talent level. Players may also compete head-to-head or against a group of players by recording each player's scores and tracking them against other players either locally (at the same facility) or remotely (another town, state or nationwide) thru an Internet web site. As used herein the term score refers to a player successfully impacting a target with a projectile. For example, in the case of a batting cage, this may constitute impacting the home run target with a baseball. Similarly, in the case of a soccer practice facility, a score would constitute hitting a target within the simulated goal.

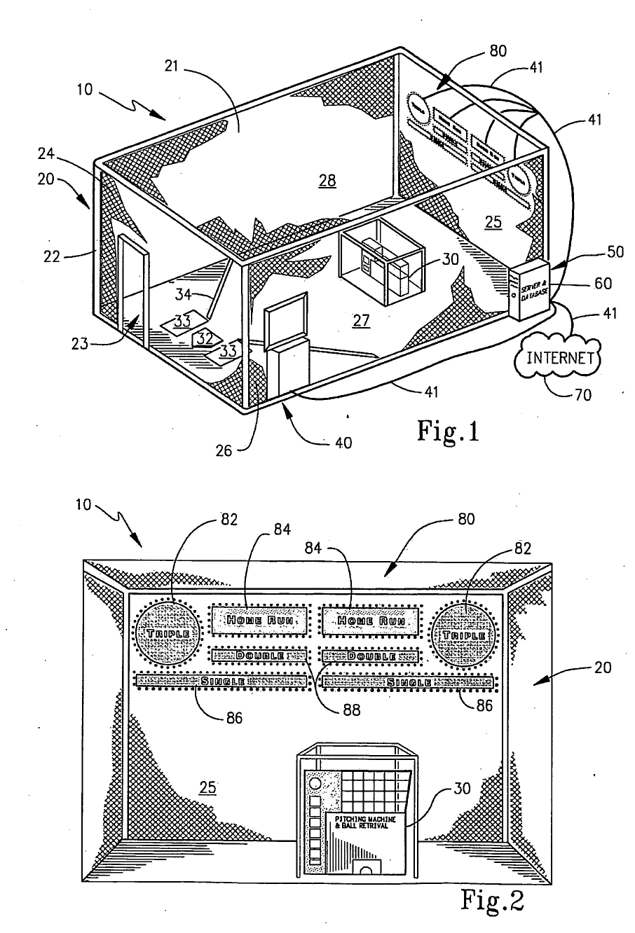

FIG. 1 illustrates a first exemplary embodiment of a practice facility 10 incorporating the real-time scoring, feedback, and long-term statistical tracking system, generally referred to as a feedback system. In general the figures diagrammatically represent various components of the system and are for explanation purposes only. In this case the practice facility 10 is a batting cage 20 configured for batting practice with softballs or baseballs. Batting cage 20 includes a cage frame 22. In this case frame 22 is 12 feet wide, 15 feet high, and 65 feet long. Frame 22 is preferably covered with netting to form roof 21, end-walls 24 and 25, and sidewalls 26 and 28. There is a door 23 for player entrance in the front of the cage 20. Simulated playing surface 27 includes a standard home plate 32 and batter's box 33 located in the striking region, which is front and center of cage 20. First and third base path lines 34 are also shown on the floor of the cage for aesthetic purposes. Batting cages as described above are available from suppliers, such as Athletic Training Equipment Company, Inc. of Sparks, Nev.

A point-of-sale and session display kiosk 40 is located in the front of the cage 20 in the right corner. Pitching and ball retrieval machine 30 is located in the center of the cage 20. Suitable pitching and ball retrieval machinery 30 is available from suppliers, such as Athletic Training Equipment Company, Inc. of Sparks, Nev. Scoring area or target region 80 includes targets (single 86, double 88, triple 82, and home run 84) that are securely mounted to the back wall 25 of cage 20. Each target is connected to the computer server 60 located outside the cage 20. Any suitable communication link 41, such as wireless, Ethernet cables, or the like may be used to interconnect the computer server 60, the kiosk 40, and the targets. A database 50 for maintaining player statistics may be stored in server 60. The server 60 may be located onsite or offsite and connected to kiosk 40 via a data network 70, such as the Internet. In an alternative construction the server 60 may reside within the kiosk 40.

Target region 80 is shown in more detail in FIG. 2, which shows the practice facility 10 as viewed from the batter's perspective from the front of cage 20 looking towards the target area 80 and back wall 25. Target area 80 includes two “SINGLE” targets 86 that are preferably mounted 8 feet from the floor of the cage. “SINGLE” targets 86 are preferably 10 feet long by 1 foot high. Target area 80 also includes two “DOUBLE” targets 88, which are preferably located 6 inches above the “SINGLE” targets 86. “DOUBLE” targets 88 are preferably 6 feet long by 1 foot high. “HOME RUN” targets 84 are preferably located 6 inches above the “DOUBLE” targets 88. “HOME RUN” targets 84 are preferably 6 feet long by 2 feet high. Finally, there are two circular shaped “TRIPLE” targets 82 located in the upper left and right hand corners of the target area 80. “TRIPLE” targets 82 are, in this case, approximately 3 feet in diameter.

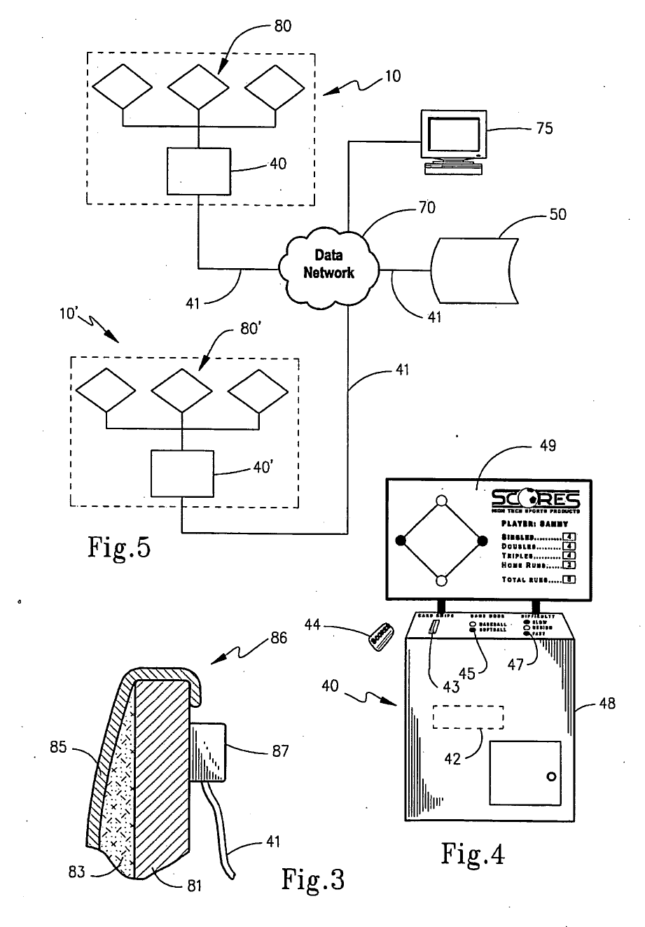

With reference to FIG. 3 (showing “SINGLE” target 86) it can be seen that each target is constructed of ½ inch thick steel plate 81. Each target also includes a durable padded cover to dampen the velocity of projectiles (in this case baseballs) in order to minimize rebounding of the projectiles. In this case the padded cover is constructed of foam 83, which is covered by a vinyl cover 85. The scoring indicia may be etched, embossed or otherwise formed or painted onto the cover 85 for easy visibility. Located on the back of each target is a sensor 87 that is stimulated when the target is struck or impacted by a projectile, thereby triggering a feedback signal indicative of the projectile impacting the target. Sensor 87 may be of the type known as a knock or vibration sensor to name a representative few. The sensor 87 electronically sends the impulse to connected computer hardware and software. Sensors, connections, and wiring are constructed to withstand inclement weather (rain, snow, sleet, hail, etc.) and temperature ranges (−10 to +120 degrees Fahrenheit).

As targets are hit and scores are registered the player's score is displayed in real time on the point-of-sale kiosk 40 next to the batter in the front of the cage. As illustrated in FIG. 4 the display kiosk 40 is comprised of a base portion 48 and a display portion 49. The base portion 48 is constructed of a 3-foot by 3 foot, square steel box. Base portion 48 includes a bar-coded card reader 43, a ball speed/difficulty selector 47, a ball type (baseball or softball in this case) selector 45 and a game-processing computer 42. The display portion 49 of the kiosk 40 is preferably a 24-inch display screen housed in ½ inch thick fiberglass secure casing for security and protection. Preferably, the kiosk is built to withstand inclement weather (rain, snow, sleet, hail, etc.) and temperature ranges (−10 to +120 degrees Fahrenheit).

The display kiosk 40 houses a computer 42 that tallies the player's scores and calculates simulated player movements and positions, which are then displayed on display 49. Card reader 43 reads pre-registered bar-coded customer cards 44, which are tracked to individual account numbers. Players may obtain a customer card 44 by filling out a preprinted registration form or registering online via the Internet. Players swipe their card 44 thru card reader 43 to start each game session. All targets hit are recorded and tracked to the player's account number. The customer's card 44 preferably holds characteristic information about the player such as name, age, height, skill level, preferred pitching speed, batting average, ranking, and the like. Based on the player's information the computer 42 can automatically adjust for ball speed and simulated player movements, for example. Thus the system compensates for players' differences allowing fair head to head play between players of disparate skill level or age. The kiosk 40 may accept prepaid payments for a session via the customer cards 44 and the card reader 43. Alternatively, the kiosk may use point of sale payment options.

Hits, runs, and goals scored are tracked via server 60 with database software 50 that logs and tracks each successfully hit target. Preferably the statistics are uploaded in real time from the kiosks 40 to the database 50. FIG. 5 illustrates a representative network where a plurality of practice facilities 10 and 10′ are connected to the central database 50 via a data network 70, such as the Internet. Players can access their statistics (hits, runs, batting average, RBIs, goals scored, national rankings, etc.) and where they rank nationally within their age or skill group. Players may also join leagues on a web site using a secure login and password that is unique for each player. Players may view previous session statistics anytime via a standard Internet web site connection 75.

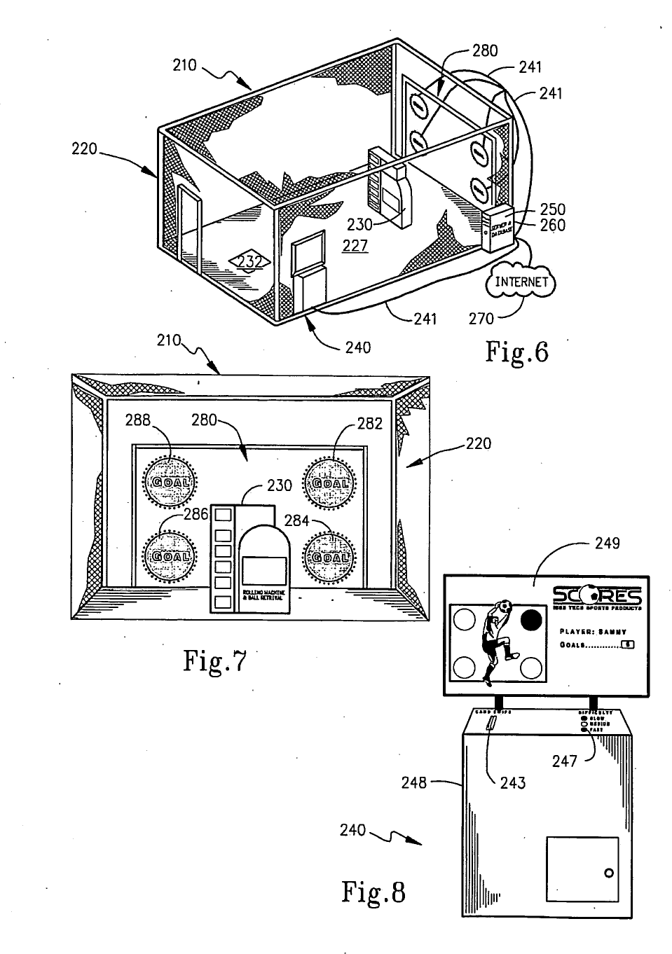

FIGS. 6-8 show a soccer practice facility 210. Soccer practice facility 210 is similar to the practice facility shown in FIGS. 1-5 except that the playing surface 227, target area 280, and machinery 230 are configured for practicing soccer. Soccer practice facility 210 includes a cage 220, which is 12 feet wide and 65 feet long. A point-of-sale and session display kiosk 240 is located in the front of the cage in the right corner. A square box 232 is located near the front of the cage on playing surface 227 and is used as the player's starting point for kicking balls that are rolled to the player in regular intervals. Ball rolling and retrieval machinery 230 is located in the center of the cage near the back with a protective screen or fencing in front for protection. Game targets 282, 284, 286, and 288 are located in the upper and lower corners of a simulated soccer goal at the back of the cage. Each target is connected to the computer kiosk 240. The computer server 260 is connected either directly or via the Internet, to the point-of-sale and display kiosk 240. The targets, kiosk, and server may all be interconnected with any suitable communication link 241, such as wireless, Ethernet cables, or the like.

Accordingly, the present invention has been described with some degree of particularity directed to the exemplary embodiments of the present invention. It should be recognized, however, that the present invention is defined by the following claims construed in light of the prior art so that modifications or changes may be made to the exemplary embodiments of the present invention without departing from the inventive concepts contained herein.

What is claimed is:

1. In a practice facility that simulates a sport playing environment, wherein the facility has a projectile striking region and a target region for the projectile, the improvement comprising a computerized feedback system that includes:
a. an input device for receiving participant credentials sufficient to activate the computerized feedback system;
b. an output device for displaying perceptible output to a participant;
c. a target array including at least one target removably mounted in the target region and operative, when stimulated by the projectile, to produce at least one feedback signal; and
d. a data processing device adapted to:
i. receive each said feedback signal produced by the target array;
ii. process selected said feedback signals according to rules for the sport, thereby to generate processed data; and
iii. selectively transmit said processed data to the output device.

2. The improvement according to claim 1 wherein each said target is stimulated upon impact by the projectile.

3. The improvement according to claim 1 wherein said target array includes a plurality of targets correlated to the sport.

4. The improvement according to claim 1 wherein said input device and said output device are included in a kiosk.

5. The improvement according to claim 4 wherein said credentials and selected said processed data are stored on a memory device readable by said kiosk.

6. The improvement according to claim 5 wherein said data processing device is adapted to update data stored on said memory device.

7. The improvement according to claim 5 wherein said input device is a card reader.

8. A gaming system simulating a competitive sport involving a projectile, comprising:
a. a plurality of practice facilities each including:
i. a simulated playing environment correlated to the sport, wherein the playing environment has a projectile striking region and a target region for the projectile;
ii. a target array including at least one target removably mounted in the target region and operative, when stimulated by the projectile, to produce at least one feedback signal; and
iii. a kiosk including an input device for receiving participant credentials and an output device for displaying perceptible output to the participant; and
b. a data processing system including at least one data processing device associated with each facility, said data processing system adapted to:
i. receive said feedback signals produced by the target arrays;
ii. process selected ones of said feedback signals according to rules for the sport, thereby to generate processed data; and
iii. selectively transmit said processed data to the output devices.

9. A gaming system according to claim 8 wherein said data processing system is adapted to determine relative skill levels among participants, thereby to generate ranking data.

10. A gaming system according to claim 9 wherein selected said ranking data is stored on a memory device readable by said kiosk.

11. The improvement according to claim 10 wherein said data processing system is adapted to update data stored on said memory device.

12. A gaming system according to claim 8 wherein each said kiosk includes a data processing device.

13. A gaming system according to claim 8 wherein said target array includes a plurality of targets correlated to the sport.

14. A gaming system according to claim 13 wherein each said target is stimulated upon impact by the projectile.

15. A gaming system according to claim 14 wherein the sport is selected from the group consisting of baseball, softball, soccer, tennis, hockey, and golf.
